(19) United States
(12) Patent Application Publication
(10) Pub. No.: US 2023/0249531 A1
(43) Pub. Date: Aug. 10, 2023

(54) GEARBOX APPARATUS FOR A DRIVE TRAIN OF A MOTOR VEHICLE

(71) Applicant: ZF FRIEDRICHSHAFEN AG, Friedrichshafen (DE)

(72) Inventors: Fabian RÜGER, Werneck (DE); Oliver BAYER, Hörbranz (AT); Steffen TREUTLEIN, Werneck (DE); Gerhard MÜLLER, Immenstaad am Bodensee (DE); Michael KOHR, Bodnegg (DE); Thomas SCHUPP, Bodnegg (DE); Niklas SCHWARZMANN, Lindau (DE)

(21) Appl. No.: 18/166,024

(22) Filed: Feb. 8, 2023

(30) Foreign Application Priority Data
Feb. 10, 2022 (DE) 10 2022 201 391.3

(51) Int. Cl. B60K 1/02; F16H 57/031; F16H 57/029; F16H 57/04; H02K 7/116; H02K 11/21

(52) U.S. Cl. CPC B60K 1/02; F16H 57/031; F16H 57/029; F16H 57/0476; H02K 7/116; H02K 11/21; F16H 2057/02043

(57) ABSTRACT

Gearbox apparatus for a drive train of a motor vehicle, having at least two electric machines which are assigned to a common gearbox device, the at least two electric machines being arranged in parallel and being arranged together with an electronics device, designed in particular for the electrical supply of the two electric machines, so as to overlap in the axial direction at least in portions in a common spatial volume.

### BACKGROUND OF INVENTION

### 1. Field of the Invention

The disclosure relates to a gearbox apparatus for a drive train of a motor vehicle, comprising at least two electric machines assigned to a common gearbox device.

### 2. Description of Related Art

Gearbox apparatuses for drive trains of motor vehicles are known in principle from the prior art. These gearbox apparatuses have two electric machines which are assigned to the same gearbox device, i.e. they can transmit torque to the same driven shaft or output shaft. Usually, the electric machines in such gearbox apparatuses are arranged and set up depending on the prevailing installation space situation or the available installation space.

It is known here that, based on the arrangement and orientation of the electric machines, there is also an arrangement of the electronics device that supplies the particular electric machine. In this case, it is either necessary to assign each of the electric machines its own electronics device, for example power electronics, or to route supply lines from a common electronics device to the connections of the particular electric machines accordingly.

Since the position of the individual electric machines in the gearbox apparatus is thus determined by the available installation space, the electronics device is usually also arranged in an installation space available for this purpose, and supply lines are routed to the electric machines accordingly. This usually has the disadvantage that comparatively long supply lines to the electric machines are required and, depending on the specific installation space situation, comparatively time-consuming dismantling of individual components of the gearbox apparatus is necessary in order to service the electronics device.

### SUMMARY OF THE INVENTION

An object of one aspect of the present invention is a gearbox apparatus that is improved by comparison.

As described, one aspect of the invention relates to a gearbox apparatus for a drive train of a motor vehicle, which gearbox apparatus comprises at least two electric machines assigned to the same or a common gearbox device. The assignment of the two electric machines with the common gearbox device means in particular that both electric machines can transmit torque to a common output of the gearbox device. For example, both electric machines are coupled to the same output shaft and can thus both transmit torque to the output shaft alternately and/or simultaneously.

One aspect of the invention is based on the finding that the at least two electric machines are arranged in parallel and, together with an electronics device designed in particular for the electrical supply of the two electric machines, are arranged overlapping in the axial direction at least in some portions in a common spatial volume. The common spatial volume ultimately defines a three-dimensional area delimited in the axial direction, in which a portion of both the electronics device and both electric machines is located. Viewed in a longitudinal section, the two electric machines and the electronics device therefore overlap in the common spatial volume. Here, it is not necessary that the common spatial volume also physically represents a common closed volume, rather the two electric machines can be arranged in a housing, in particular a gearbox housing, i.e. a housing of the gearbox device, wherein the electronics device can be arranged in a separate electronics housing or outside the gearbox housing in which the two electric machines are arranged.

Rather, the common spatial volume is to be understood independently of delimitations by housing walls and the like and serves to define the arrangement of the electric machines and the electronics device in the space or within the gearbox apparatus. In other words, both electric machines and the electronics device are thus located with at least one portion in the same axial position. As usual, the axial direction is understood to be the position of the axes or shafts of the electric machines, i.e. in particular the rotor shafts or the rotary axes of the electric machines define the axial direction. An axial plane is therefore perpendicular to the axial direction or the rotor shafts and rotary axes.

The arrangement of the electronics device and the two electric machines proposed within the scope of the application allows both electric machines to be supplied by the electronics device and the arrangement of both electric machines, and the electronics device in such a way that they overlap in the axial direction in the common spatial volume allows a particularly advantageous routing of the electrical supply lines from the electronics device to the electric machines. Furthermore, the electronics device can be arranged here in such a way that it is particularly easily reached for maintenance of the electronics device and it is therefore not necessary to dismantle large parts of the gearbox apparatus in order to gain access to the electronics device.

The proposed arrangement of the electronics device and both electric machines is thus made in a departure from the common principle of arranging electric machines in gearbox apparatuses in places that remain free due to a selected wheel set or the like. Instead, the invention is based on arranging the electronics device and both electric machines in a common spatial volume so that the resulting advantages can be utilized. The gearbox apparatus may comprise exactly one electronics device for the electrical supply of a plurality of electric machines. In this case, the gearbox apparatus can have exactly two electric machines and exactly one electronics device.

In particular, the two electric machines can be provided for the drive of the motor vehicle and, as described previously, can alternately or in combination provide a torque for the drive of the motor vehicle. Furthermore, it is possible that one or both electric machines can be set to a generator mode, for example to charge an electric energy storage device of the motor vehicle. The gearbox device may comprise a wheel set that may be designed to provide multiple gear ratios. The wheel set provided by the gearbox device is at least partially used by the two electric machines. This means that at least one gear is provided for each of the electric machines. In particular, it can be provided here that each of the electric machines can use all gears of the wheel set alone or in combination with the other electric machine.

According to one aspect of the gearbox apparatus, it can be provided that the electronics device is designed to be removable, in particular connected to the at least two electric machines by detachable connection elements. The electronics device can, for example, provide connection elements that can be connected to corresponding supply lines by detachable connection elements. For example, contact portions for the electrical contacting of the electronics device with the supply lines for the electric machines can be screwed or plugged in. Furthermore, detachable connection elements can be provided, with which the electronics housing is connected to the gearbox housing. The connection elements are accessible either via the electronics housing or via a maintenance flap or a maintenance opening in the gearbox housing. Thus, it is possible to release the detachable connection elements and thus remove the electronics device from the gearbox apparatus. This allows the electronics device to be separated from the gearbox apparatus, in particular for maintenance purposes. It is also possible, for example in the event of a defect in the electronics device, to replace the electronics device with an intact electronics device in this way.

The electronics device can be arranged outside a gearbox housing, in particular delimiting an oil chamber of the gearbox device, at least one maintenance opening, in particular closable by a maintenance flap, being formed in the gearbox housing, through which at least one connection element, by which the electronics device is connected to the at least two electric machines, is accessible. According to this embodiment, it is provided that the electronics device is arranged outside the gearbox housing in which the electric machines are arranged. Such a gearbox housing usually represents an oil chamber in which a gearbox device comprising a wheel set is arranged next to the electric machines. The gearbox housing here has a maintenance opening which can advantageously be closed by a maintenance flap. Through the maintenance opening it is possible to reach a connection element which is provided for connecting the electronics device to the at least two electric machines.

In other words, it is thus possible to reach the connection element from the outside without dismantling parts of the gearbox device. Furthermore, it is possible for oil to remain filled in the oil chamber delimited by the gearbox housing, since the maintenance opening allows access to the connection contacts in order to disconnect the electronics device from the connection elements and thus from the at least two electric machines. Subsequently, the electronics device can be removed, in particular together with the electronic housing assigned to the electronics device. In addition, further mechanical connection means can be provided in the interior of the electronics housing, which, for example, arrange the electronics housing on the gearbox housing. All connection elements can be sealed here so that the tightness of the gearbox housing is maintained. The maintenance opening described is advantageously provided in the region of the connection of the electronics device.

According to a further embodiment of the gearbox apparatus, it can be provided that at least one connection element, in particular all connection elements, of the electronics device and of the two electric machines are arranged in the common spatial volume, in particular in an overlapping region, in particular in the same axial plane. The at least one connection element, for example an electrical contact, in particular all electrical contacts, are thus arranged in the common spatial volume. In particular, all electrical contacts with which the electronics device is connected to the two electric machines can be arranged in the same axial plane or at the same axial level The connection elements designate here in particular an electrical connection between the electronics device and the electric machines. Such electrical connection elements are also referred to as “bus bars”. These can be used in particular for the power supply of the electric machines by the electronics device, which can also be referred to as “power electronics”.

By arranging the connection elements in the same axial plane, a particularly favourable routing of the electrical supply lines is possible. Since both electric machines and the electronics device ultimately have their electrical connections in the same axial plane, the shortest possible electrical supply lines can be selected.

At least one connection element, in particular all connection elements, can be guided through a housing of the electronics device and the gearbox housing, in particular in a sealed manner. Accordingly, the connections provided for the power supply from the electronics device to the electric machines are guided in a sealed manner through a housing of the electronics device and the gearbox housing. Usually, three connection elements are provided here for each of the electric machines in order to supply power to the electric machines.

According to a further aspect of the gearbox apparatus, it can be provided that the at least two electric machines are designed similarly or differently and/or that the output sides of the at least two electric machines are oriented identically or oppositely. Accordingly, the electric machines can be designed to be fundamentally different, i.e. they can have different power values or form factors. For example, the two electric machines can be designed with different lengths in the axial direction. Furthermore, it is possible to use electric machines with different diameters or to have further differences characterizing the operation of the electric machine, for example different magnetic elements. Likewise, similar electric machines, in particular identical electric machines, can be used.

Irrespective of whether similar or different electric machines are used, a similar or opposite orientation of the electric machines can be provided, i.e. their output sides point in the same direction in the axial direction or in different directions in the axial direction, i.e. in particular in the axial direction and against the axial direction.

The connection elements of the electric machines can be arranged here on the same axial side. An axial side is understood here to be a side of the electric machine pointing in the same axial direction. This means that, regardless of the orientation of the electric machines, both electric machines have their connection elements on the same side in relation to the axial direction of the gearbox apparatus. For example, according to this aspect, both electric machines have their connection elements on the side of the gearbox input or on the side of the gearbox output, regardless of the direction in which the output sides of the electric machines point.

According to a further aspect of the gearbox apparatus, at least one oil feed can be provided, which is guided in one of the rotor shafts of the electric machines. In particular, the oil feeds can be guided here in both rotor shafts of the at least two electric machines. The oil feed can be guided on the side of the output element, for example a pinion, or on the opposite side of the rotor shaft. This allows a particularly efficient supply of oil into the electric machine, in particular through the rotor shaft of the electric machine.

The described gearbox apparatus can further be developed in that at least one sensor, in particular a rotor angle sensor, is arranged at the end of a rotor shaft of one of the electric machines, in particular plugged in from the outside. This allows a particularly efficient arrangement of the sensor, in which the sensor is also accessible from the outside, for example in the event of maintenance. If the sensor is to be dismantled from the electric machine, it can be accessed from the outside, in particular by being disconnected from the rotor shaft by releasing a plug-in connection.

In addition to the gearbox apparatus, the invention relates to a motor vehicle comprising a gearbox apparatus described above. All advantages, details and features described with respect to the gearbox apparatus are fully transferable to the motor vehicle.

### BRIEF DESCRIPTION OF THE DRAWINGS

The invention will be explained below by exemplary embodiments with reference to the figures. The figures are schematic representations and show:

FIG. 1 is a gearbox diagram of a gearbox apparatus;

FIG. 2 is an axial view of the gearbox diagram from FIG. 1;

FIG. 3 is a perspective view of a first electric machine of the gearbox apparatus from FIGS. 1 and 2;

FIG. 4 is a longitudinal section of the electric machine from FIG. 3;

FIG. 5 is a perspective view of a second electric machine of the gearbox apparatus from FIGS. 1 and 2; and

FIG. 6 is a longitudinal section of the electric machine from FIG. 5.

### DETAILED DESCRIPTION OF THE PRESENTLY PREFERRED EMBODIMENTS

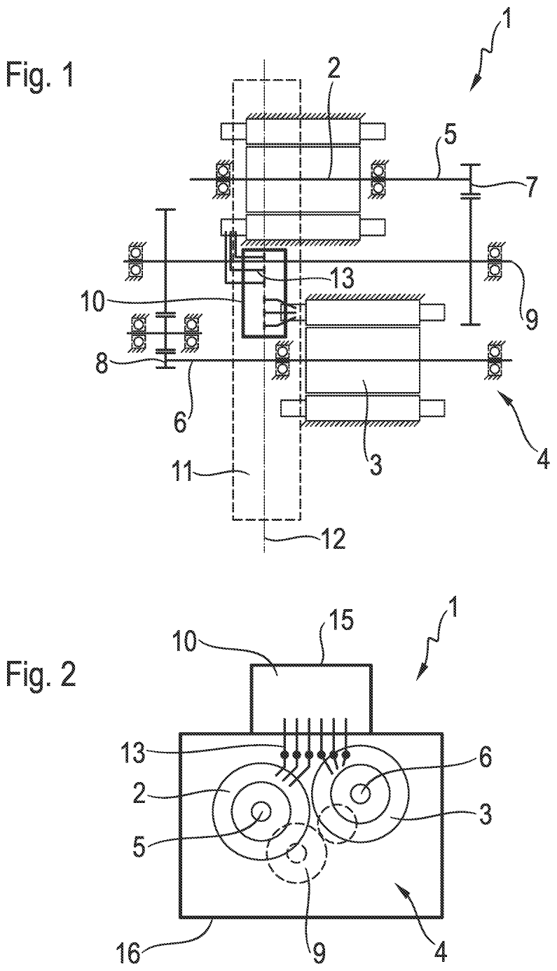

FIG. 1 shows a gearbox apparatus 1 for a drive train, not shown in greater detail, for a motor vehicle. The gearbox apparatus 1 comprises two electric machines 2, 3 which are assigned to a common gearbox device 4. The two electric machines 2, 3 shown are merely to be understood as examples. Likewise, a different orientation or arrangement of the electric machines 2, 3 is possible. The number of electric machines 2, 3 can also be increased as desired.

The electric machines 2, 3 are arranged in parallel, i.e. their rotor axes 5, 6 are oriented identically. Here, an output element 7 of the “first” electric machine 2 points in a “first” axial direction, for example in the direction of a gearbox output, and an output element 8 of the “second” electric machine 3 points in a “second” axial direction, i.e. in the opposite axial direction, for example in the direction of a gearbox input. The two electric machines 2, 3 are assigned to the same gearbox device 4, i.e. they can transmit torque to the same output shaft 9. Likewise, the gearbox device 4 can be assigned a wheel set, not shown in greater detail, which both electric machines 2, 3 can use. Here it is possible in particular to operate the electric machines 2, 3 separately or together.

The gearbox apparatus 1 also has an electronics device 10, for example power electronics, which is designed to supply the electric machines 2, 3 with electrical energy. Here, FIG. 1 shows a common spatial volume 11 in which the two electric machines 2, 3 and the electronics device 10 overlap, i.e. at least one portion of each of the two electric machines 2, 3 and of the electronics device 10 is arranged in the common spatial volume 11. In particular, in this embodiment it is shown that the connection elements 13, for example electrical contacts, of the electronics device 10 are all located in one axial plane 12, i.e. that all connection elements 13 (“bus bars”) are arranged in the axial plane 12, by which connection elements 13 the electronics device 10 is connected to the electric machines 2, 3. Here, as is usual, three connection elements 13 are provided for the supply of each of the two electric machines 2, 3.

FIG. 2 shows the common spatial volume 11, in particular the axial plane 12 in a schematic cross-sectional view. It is thus evident that the connection elements 13 are all arranged in the same axial plane 12, so that particularly short electrical supply lines can be provided between the electronics device 10 and the electric machines 2, 3. FIG. 2 also shows that the electronics device 10 is arranged outside a gearbox housing 14, namely inside an electronics housing 15. The gearbox apparatus 1 has a maintenance opening here which allows the connection elements 13 to be reached from the outside and in particular the electronics device 10 to be detached from the gearbox housing 14, for example by the connection elements 13 being designed to be detachable, for example screwed or plugged in. Furthermore, further mechanical connection elements can be provided with which the electronics housing 15 is arranged on the gearbox housing 14, for example screws. In particular, these can be sealed in such a way that the interior of the gearbox housing 14 remains oil-tight.

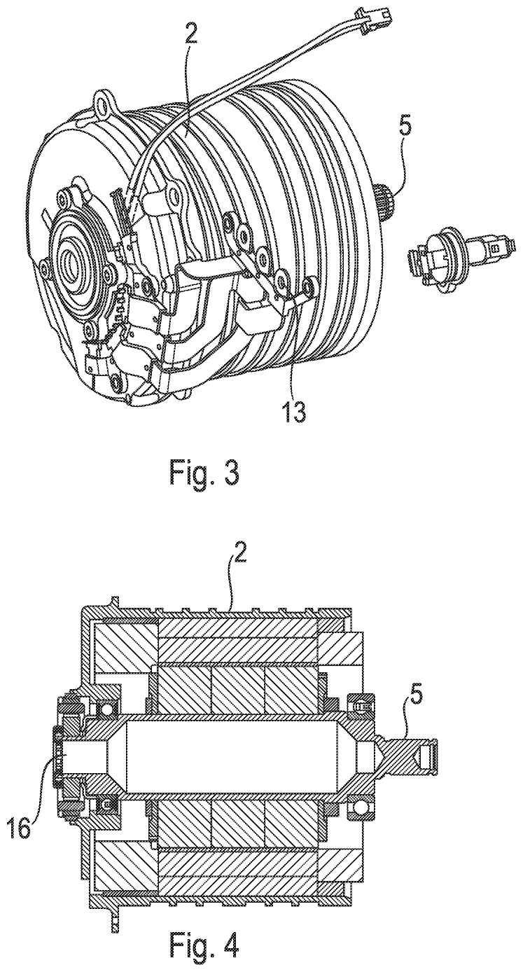

FIGS. 3 and 4 show the electric machine 2 in a perspective view and in a longitudinal section. It can be seen that the connection elements 13 of the electric machine 2 are arranged on the axial side opposite the direction in which the output element 7 points on the rotor axis 5. For example, the connection elements 13 of the electric machine 2 are arranged on the side of a gearbox input. FIG. 4 shows a longitudinal section of the electric machine 2, wherein an oil feed 16 is provided, which is arranged in the rotor shaft 5 of the electric machine 2.

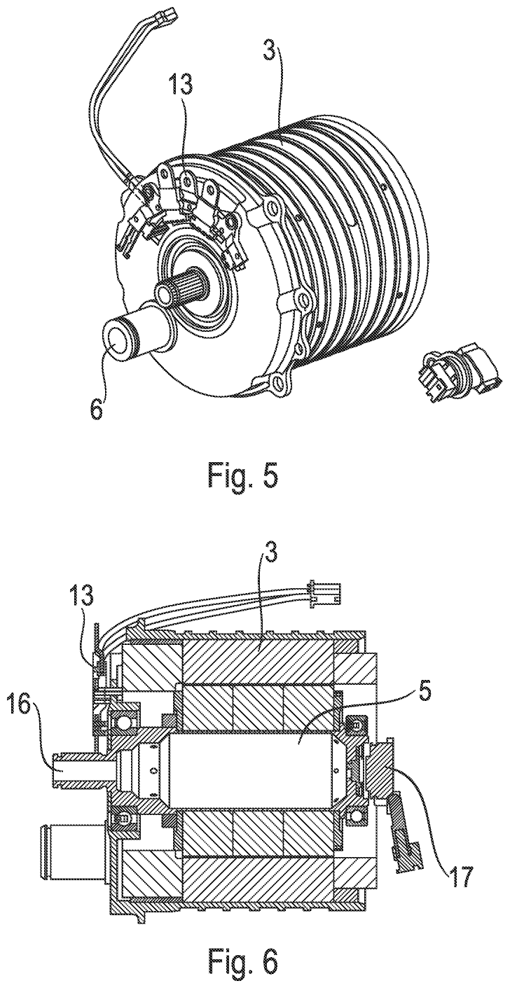

FIGS. 5 and 6 show the electric machine 3 in a perspective view and in a longitudinal section. Here the electric machine 3 has the connection elements 13 on the axial side on which the rotor shaft 6 and the output element 8, for example a pinion, are arranged. Since the two electric machines 2, 3, as shown in FIG. 1, are arranged or oriented in opposite directions, i.e. their output elements 7, 8 point in different axial directions, the electric machines 2, 3 have the connection elements 13 at other points on the electric machines 2, 3. In this case, however, the connection elements 13 are arranged on the same axial side, namely in this exemplary embodiment on the side of the output element 8 of the second electric machine 3. The exemplary embodiment shown is merely exemplary in this point. It would also be possible to reverse the arrangement of the connection elements 13 or to arrange the electric machines 2, 3 the other way round or to have both electric machines 2, 3 point in the same axial direction with their output elements 7, 8.

The electric machine 3 also has an oil feed 16 inside the rotor shaft 6, as shown in FIG. 6. Furthermore, the electric machine 3 has a sensor 17, in particular a rotor angle sensor, which is arranged at the end of the rotor shaft 6 of the electric machine 3. In this exemplary embodiment, the sensor 17 is plugged into the rotor shaft 6 from the outside so that the sensor is accessible from the outside and can be detached or replaced if necessary.

The details, advantages and features shown in the individual exemplary embodiments are interchangeable, transferable to each other, and combinable with each other.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A Gearbox apparatus for a drive train of a motor vehicle, comprising:
a common gearbox device;
at least two electric machines arranged in parallel and overlapping in an axial direction at least in some portions in a common spatial volume and which are assigned to the common gearbox device; and
an electronics device configured to electrically supply the at least two electric machines.

2. The gearbox apparatus according to claim 1, wherein the electronics device is configured to be removable.

3. The gearbox apparatus according to claim 1, wherein:
the electronics device is arranged outside a gearbox housing and delimiting an oil chamber of the common gearbox device;
at least one maintenance opening, configured to be closed by a maintenance flap formed in the gearbox housing, through which at least one connection element, by which the electronics device is connected to the at least two electric machines, is accessible.

4. The gearbox apparatus according to claim 1, wherein at least one connection element of the electronics device and of the at least two electric machines are arranged in the common spatial volume, in a same axial plane.

5. The gearbox apparatus according to claim 4, wherein the at least one connection element is guided through an electronics housing of the electronics device and a gearbox housing in a sealed manner.

6. The gearbox apparatus according to claim 1, wherein the at least two electric machines are designed similarly or differently, and/or in that output sides of the at least two electric machines are oriented identically or oppositely.

7. The gearbox apparatus according to claim 1, wherein connection elements of the at least two electric machines are arranged on a same axial side.

8. The gearbox apparatus according to claim 1, wherein at least one oil feed is guided in at least one rotor shaft of one of the at least two electric machines.

9. The gearbox apparatus according to claim 1, wherein at least one sensor, configured as a rotor angle sensor, is arranged at an end of a rotor shaft of one of the at least two electric machines.

10. The gearbox apparatus according to claim 1, wherein the electronics device is configured to be removeably connected to the at least two electric machines by detachable connection elements.

11. The gearbox apparatus according to claim 9, wherein the at least one sensor, is plugged in from an outside.

12. A motor vehicle comprising;
a gearbox apparatus for a drive train of the motor vehicle, comprising:
a common gearbox device;
at least two electric machines arranged in parallel and overlapping in an axial direction at least in some portions in a common spatial volume and which are assigned to the common gearbox device; and
an electronics device configured to electrically supply the at least two electric machines.
